(19) United States
(12) Patent Application Publication
(10) Pub. No.: US 2024/0098536 A1
(43) Pub. Date: Mar. 21, 2024

(54) CALIBRATION OF A LAYER 1 MEASUREMENT OUTSIDE OF AN ACTIVE BANDWIDTH PART

(71) Applicant: QUALCOMM Incorporated, San Diego, CA (US)

(72) Inventors: Prashant SHARMA, San Jose, CA (US); Muhammad Nazmul ISLAM, Littleton, MA (US); Yongjun KWAK, San Diego, CA (US)

(21) Appl. No.: 17/932,467

(22) Filed: Sep. 15, 2022

(51) Int. Cl. H04W 24/10; H04W 56/00

(52) U.S. Cl. CPC H04W 24/10; H04W 56/001

(57) ABSTRACT

Various aspects of the present disclosure generally relate to wireless communication. In some aspects, a user equipment (UE) may obtain an indication of a bandwidth part (BWP) measurement offset associated with a layer 1 measurement. The UE may communicate in a wireless network based at least in part on using the BWP measurement offset with the layer 1 measurement. Numerous other aspects are described.

### FIELD OF THE DISCLOSURE

Aspects of the present disclosure generally relate to wireless communication and to techniques and apparatuses for calibration of a layer 1 measurement outside of an active bandwidth part.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a network node. The apparatus may include a memory and one or more processors coupled to the memory. The one or more processors may be configured to determine a bandwidth part (BWP) measurement offset associated with a layer 1 measurement. The one or more processors may be configured to transmit an indication of the BWP measurement offset.

Some aspects described herein relate to an apparatus for wireless communication at a user equipment (UE). The apparatus may include a memory and one or more processors coupled to the memory. The one or more processors may be configured to obtain an indication of a BWP measurement offset associated with a layer 1 measurement. The one or more processors may be configured to communicate in a wireless network based at least in part on using the BWP measurement offset with the layer 1 measurement.

Some aspects described herein relate to a method of wireless communication performed by a network node. The method may include determining a BWP measurement offset associated with a layer 1 measurement. The method may include transmitting an indication of the BWP measurement offset.

Some aspects described herein relate to a method of wireless communication performed by a UE. The method may include obtaining an indication of a BWP measurement offset associated with a layer 1 measurement. The method may include communicating in a wireless network based at least in part on using the BWP measurement offset with the layer 1 measurement.

Some aspects described herein relate to a non-transitory computer-readable medium that stores a set of instructions for wireless communication by a network node. The set of instructions, when executed by one or more processors of the network node, may cause the network node to determine a BWP measurement offset associated with a layer 1 measurement. The set of instructions, when executed by one or more processors of the network node, may cause the network node to transmit an indication of the BWP measurement offset.

Some aspects described herein relate to a non-transitory computer-readable medium that stores a set of instructions for wireless communication by a UE. The set of instructions, when executed by one or more processors of the UE, may cause the UE to obtain an indication of a BWP measurement offset associated with a layer 1 measurement. The set of instructions, when executed by one or more processors of the UE, may cause the UE to communicate in a wireless network based at least in part on using the BWP measurement offset with the layer 1 measurement.

Some aspects described herein relate to an apparatus for wireless communication. The apparatus may include means for determining a BWP measurement offset associated with a layer 1 measurement. The apparatus may include means for transmitting an indication of the BWP measurement offset.

Some aspects described herein relate to an apparatus for wireless communication. The apparatus may include means for obtaining an indication of a BWP measurement offset associated with a layer 1 measurement. The apparatus may include means for communicating in a wireless network based at least in part on using the BWP measurement offset with the layer 1 measurement.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a bandwidth part (BWP), in accordance with the present disclosure.

FIG. 4 is a diagram illustrating an example of a wireless communication process between a network node and a UE, in accordance with the present disclosure.

FIG. 5 is a diagram illustrating an example of a wireless communication process between a network node, a UE, and one or more other UEs, in accordance with the present disclosure.

FIG. 6 is a diagram illustrating an example of a wireless communication process between a network node and a UE, in accordance with the present disclosure.

FIG. 7 is a diagram illustrating an example process performed, for example, by a network node, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

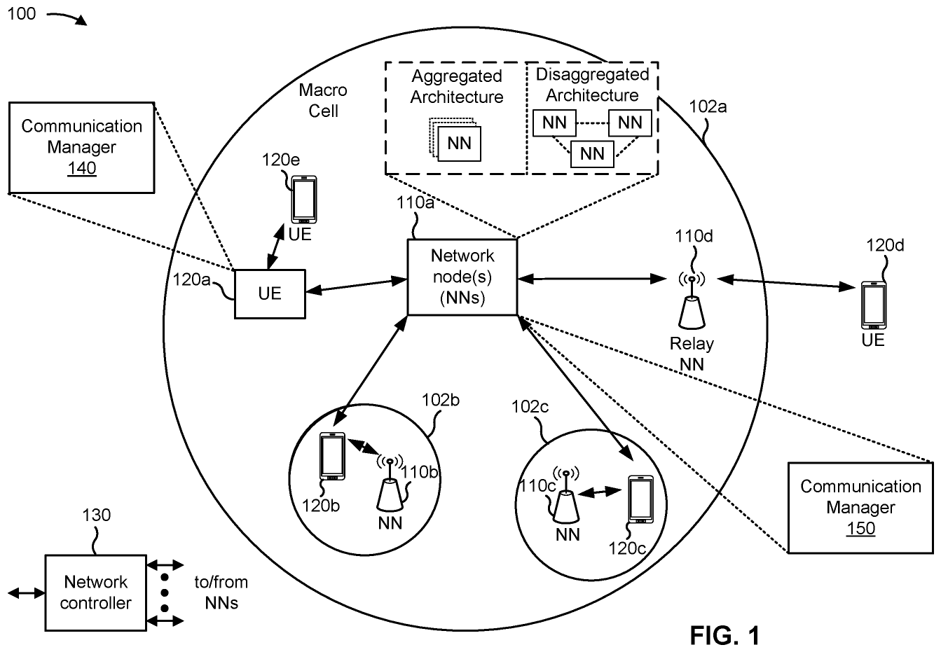

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 megahertz (MHz)-7.125 gigahertz (GHz)) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., the network node 110) may include a communication manager 150. As described in more detail elsewhere herein, the communication manager 150 may determine a bandwidth part (BWP) measurement offset associated with a layer 1 measurement; and transmit an indication of the BWP measurement offset. Additionally, or alternatively, the communication manager 150 may perform one or more other operations described herein.

In some aspects, a UE (e.g., the UE 120) may include a communication manager 140. As described in more detail elsewhere herein, the communication manager 140 may obtain an indication of a BWP measurement offset associated with a layer 1 measurement; and communicate in a wireless network based at least in part on using the BWP measurement offset with the layer 1 measurement. Additionally, or alternatively, the communication manager 140 may perform one or more other operations described herein.

As indicated above, FIG. 1 is provided as an example. Other examples may differ from what is described with regard to FIG. 1.

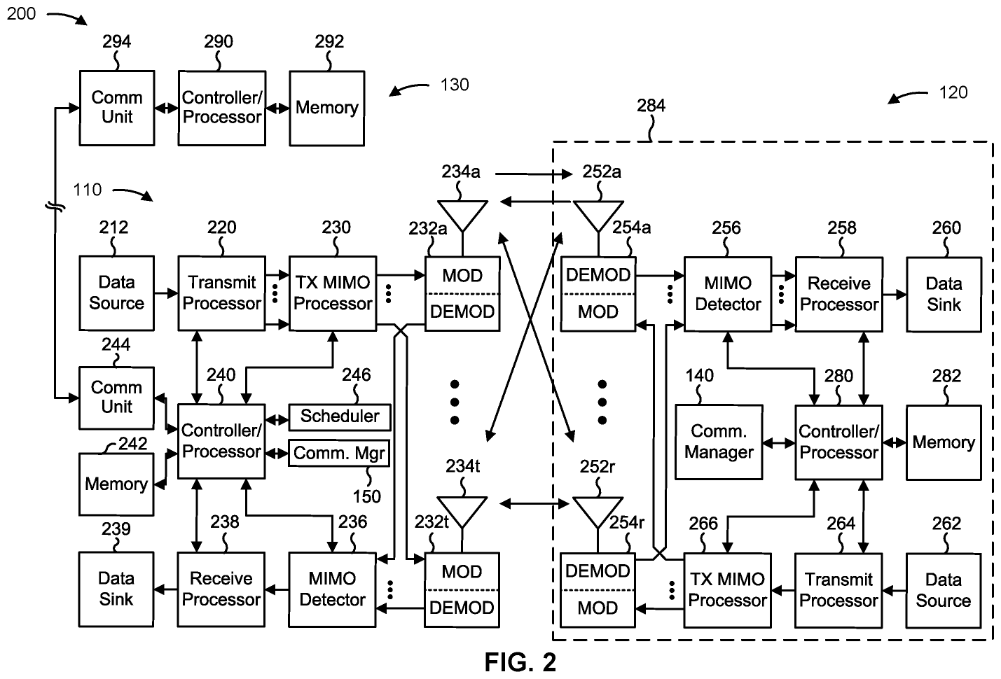

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

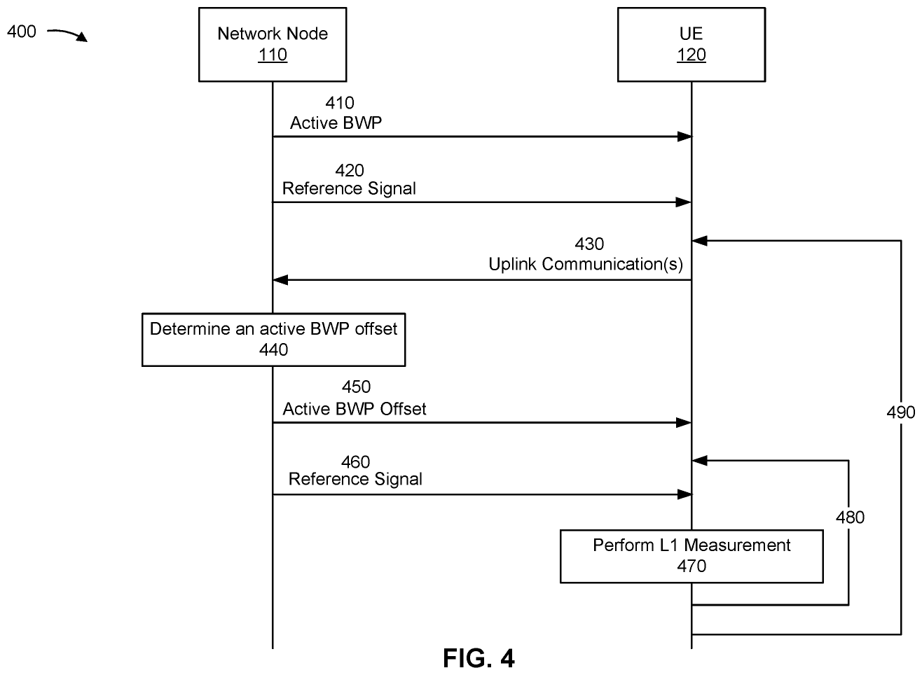

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

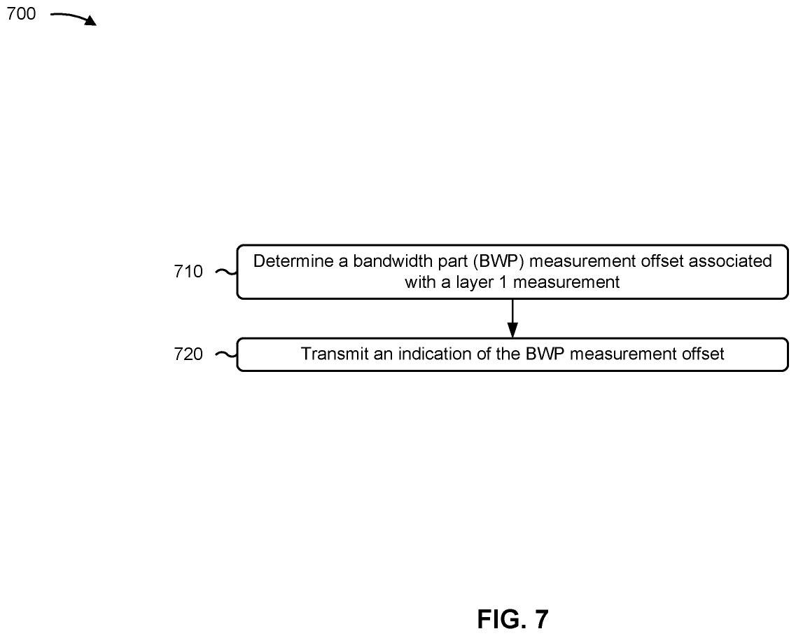

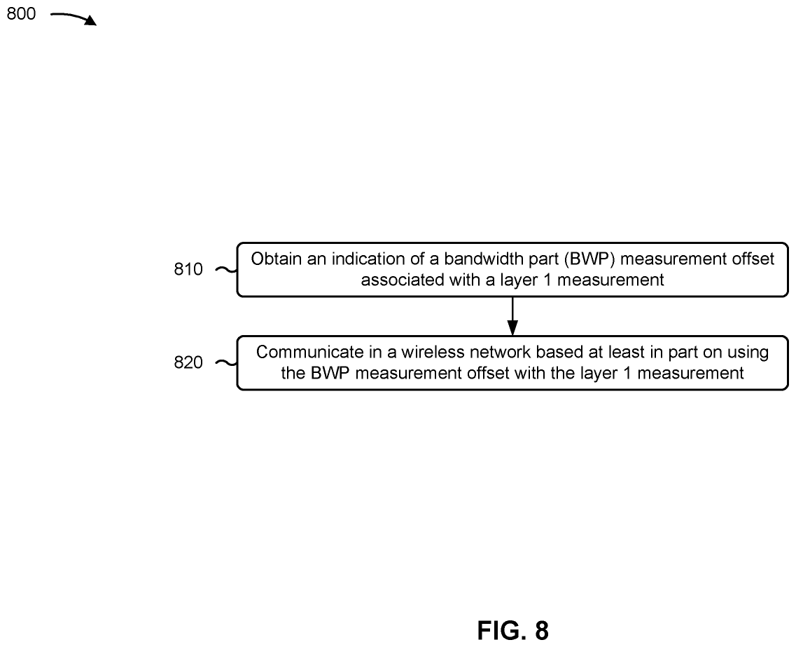

The controller/processor 240 of the network node 110, the controller/processor 280 of the UE 120, and/or any other component(s) of FIG. 2 may perform one or more techniques associated with calibration of a layer 1 measurement outside of an active bandwidth part, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a network node (e.g., the network node 110) includes means for determining a BWP measurement offset associated with a layer 1 measurement; and/or means for transmitting an indication of the BWP measurement offset. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for obtaining an indication of a BWP measurement offset associated with a layer 1 measurement; and/or means for communicating in a wireless network based at least in part on using the BWP measurement offset with the layer 1 measurement. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

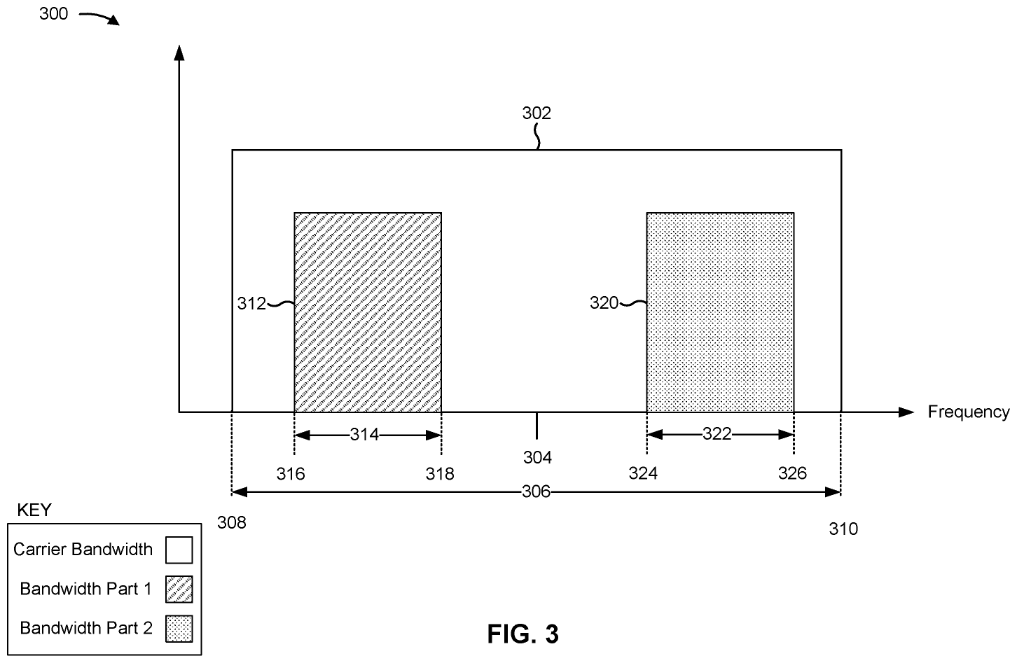

FIG. 3 is a diagram illustrating an example 300 of a bandwidth part (BWP), in accordance with the present disclosure.

In some aspects, a wireless communication channel, alternatively referred to as a “carrier”, may be based at least in part on a center frequency, a frequency bandwidth, and or a set of resource blocks (RBs). To illustrate, a carrier 302 (shown in solid white) may be based at least in part on a center frequency 304 (e.g., a carrier frequency) and a frequency bandwidth 306. The frequency bandwidth 306 of the carrier 302 may be based at least in part on a first edge frequency 308 and a second edge frequency 310. Each RB of the carrier may include a group of resource elements (REs) that are characterized by a frequency partition and a time partition. Accordingly, the set of RBs associated with the carrier 302 may collectively span a bandwidth (e.g., the frequency bandwidth 306) and time duration.

A “bandwidth part” (or “BWP”) may denote a subset of contiguous RBs (and/or REs) within the set of RBs associated with a carrier, and a carrier may be partitioned into multiple BWPs (e.g., four). The ability to partition the carrier into BWPs may provide flexibility and efficient usage of the bandwidth associated with the carrier. To illustrate, the frequency bandwidth 306 may span 100 MHz and may be referred to as a wideband channel. Some UEs, such as an IoT device and/or a reduced capacity (RedCap) device, may lack capabilities that support wideband communications. For example, an IoT device may lack a transceiver with capabilities to transmit and/or receive a wideband signal. Alternatively or additionally, the IoT device may lack a processor with capabilities to process digital samples associated with the wideband signal in real-time. Accordingly, a network node may partition a carrier into one or more BWPs for communicating with the IoT and/or other types of UEs. To illustrate, the network node may select and/or configure a first BWP 312 (shown by a diagonal line hash pattern) within the carrier 302 based at least in part on a frequency bandwidth 314, a first frequency edge 316, and a second frequency edge 318. The network node may select and/or configure a second BWP 320 (shown by a dotted pattern) within the carrier 302 based at least in part on a frequency bandwidth 322, a first frequency edge 324, and a second frequency edge 326. The network node may select a preconfigured BWP (e.g., defined by a communication standard) and/or may dynamically configure a BWP (e.g., dynamically select a bandwidth and/or a frequency edge)

Although the example 300 shows the first BWP 312 and the second BWP 320 as having equal bandwidths and being positioned symmetrically within the carrier 302, other examples may include BWPs in a same carrier that have different characteristics (e.g., frequency bandwidths). To illustrate, the first BWP 312 may be configured with a larger bandwidth relative to the second BWP 320 based at least in part on the first BWP 312 being used for a higher data throughput relative to the second BWP 320. The second BWP 320 may be configured with a smaller bandwidth relative to the first BWP 312 based at least in part on reducing a transmission size and/or processing associated with the transmission to reduce power consumption at a UE. Thus, a network node may configure and/or select a BWP based at least in part on a variety of factors, such as UE power requirements, data throughput, and/or spectrum usage. For instance, the network node may configure and/or select a BWP associated with a frequency bandwidth of 5 MHz based at least in part on using the BWP for communications with a RedCap UE and/or an IoT with limited capabilities as further described above.

In some aspects, only a single BWP of the multiple BWPs may be active per transmission direction at a given time, such as a single active BWP for uplink (UL) transmissions and/or a single active BWP for DL transmissions. Alternatively or additionally, the single active BWP may be associated with bi-directional transmissions, such as time division duplex (TDD) transmissions that share a same frequency for UL and DL transmissions based at least in part on time partitioning. Accordingly, a network node (e.g., the network node 110) may direct a UE (e.g., the UE 120) to switch from using a first BWP as an active BWP to using a second BWP as the active BWP. To illustrate, the UE may utilize an initial BWP when operating in a radio resource control idle (RRC IDLE) mode and switch to a different BWP when operating in a radio resource control connected (RRC CONNECTED) mode. That is, the UE may communicate with the network node by initially using the initial BWP as the active BWP and then switch to using the different BWP as the active BWP.

Using a smaller frequency bandwidth for an active BWP, such as a 5 MHz bandwidth as described above, may affect how a UE performs a layer 1 (L1) measurement. To illustrate, a UE may perform a variety of L1 measurements and/or procedures, such as a radio link monitoring (RLM) procedure associated with monitoring a downlink signal quality, a beam failure detection (BFD) procedure associated with determining when a beam quality fails to satisfy a quality threshold, and/or a layer 1 RSRP (L1-RSRP) measurement associated with reporting RSRP that is based at least in part on a reference signal (e.g., a synchronization signal block (SSB)). The L1 measurement procedures may generate an L1 measurement metric (e.g., by performing an L1 measurement) and compare the L1 measurement metric to a threshold to determine a channel quality state.

In some aspects, the L1 measurements and/or L1 measurement procedures (e.g., RLM, BFD, and/or L1-RSRP) may be based at least in part on a configured reference signal (e.g., a channel state information reference signal (CSI-RS) and/or an SSB). However, a configured reference signal may be based at least in part on a synchronization raster that specifies valid frequencies for transmitting the configured reference signal. That is, in some aspects, only a set of predefined frequencies may be used to transmit the configured reference signal. Accordingly, the set of predefined frequencies may result in a reference signal with a transmission frequency located outside of an active BWP, such as an active BWP with a small bandwidth (e.g., 5 MHz).

An L1 measurement that is based at least in part on a reference signal located outside of the active BWP may fail to characterize a transmission channel that is based at least in part on the active BWP. To illustrate, a transmission channel associated with a carrier configured with a 100 MHz bandwidth may introduce different distortions at different frequencies, such as a first power level distortion at a first frequency and a second, different power level distortion at a second frequency. Accordingly, a reference signal with a first transmission frequency that is 60 MHz outside of an active BWP may experience different distortion relative to a second signal with a second transmission frequency within the active BWP. An L1-RSRP measurement that is based at least in part on the first transmission signal (e.g., the reference signal that is positioned 60 MHz outside of the active BWP) may result in an L1-RSRP measurement metric that introduces errors when applied to the active BWP. For instance, a network node selecting a transmission configuration based at least in part on the L1-RSRP may select a first transmission configuration that results in increased recovery errors, reduced data throughput, and/or increased data transfer latencies relative to a second transmission configuration. Alternatively or additionally, an L1 measurement procedure may falsely detect failures.

Some techniques and apparatuses described herein provide calibration of an L1 measurement outside of an active BWP. A UE may obtain an indication of a BWP measurement offset associated with an L1 measurement and communicate in a wireless network based at least in part on using the BWP measurement offset in the L1 measurement. A “BWP measurement offset” may denote a metric that indicates a difference and/or offset between a first measurement associated with a first frequency located within an active BWP and a second measurement associated with a second frequency located outside of the active BWP. As one example, the BWP measurement offset may be based at least in part on a difference between signal metrics (e.g., RSRP or RSRQ) that are generated based at least in part on a first wireless signal located outside of an active BWP and a second wireless signal located within the active BWP. That is, the BWP measurement offset may be associated with a specific measurement. Alternatively or additionally, the UE may obtain an indication of multiple BWP measurement offsets, and each BWP measurement offset may be associated with a respective (and different) measurement. Using a BWP measurement offset to calibrate an L1 measurement metric may enable communication in the wireless network by improving an accuracy of the L1 measurement metric that is applied to the BWP measurement offset and/or reducing false failure detections by an L1 measurement procedure.

In some aspects, a network node may determine a BWP measurement offset associated with an L1 measurement, and transmit an indication of the BWP measurement offset (e.g., to a UE). As one non-limiting example, the network node may generate a BWP measurement offset profile that associates one or more BWP measurement offsets with a transmission channel. In some aspects, the network node may determine multiple BWP measurement offsets and/or multiple BWP measurement offset profiles, and each BWP measurement offset and/or BWP measurement offset profile may be associated with a specific (and different) measurement. The transmission channel may be based at least in part on the active BWP, a second BWP that is outside of the active BWP, and/or a carrier frequency bandwidth. The network node may determine the BWP measurement offset based at least in part on the BWP measurement offset profile and the active BWP.

A BWP measurement offset may improve an accuracy of an L1 measurement and/or an L1 measurement procedure performed by a UE. For instance, the UE may generate an L1 measurement metric and/or perform an L1 measurement procedure based at least in part on a reference signal located outside of the active BWP, and use the BWP measurement offset to calibrate the L1 measurement metric and/or L1 measurement procedure for a signal located within the active BWP. The calibration may improve an accuracy of the L1 measurement metric relative to an uncalibrated L1 measurement metric. The improved accuracy may reduce false failure detections by an L1 measurement procedure and/or enable a network node to select a transmission configuration that results in reduced recovery errors, increased data throughput, and/or reduced data transfer latencies relative to a second transmission configuration.

As indicated above, FIG. 3 is provided as an example. Other examples may differ from what is described with regard to FIG. 3.

FIG. 4 is a diagram illustrating an example 400 of a wireless communication process between a network node (e.g., the network node 110) and a UE (e.g., the UE 120), in accordance with the present disclosure.

As shown by reference number 410, a network node 110 may transmit, and a UE 120 may receive, an indication of an active BWP. As one example, the network node 110 may transmit a radio resource control (RRC) message that indicates an active DL BWP for a downlink communication and/or an active UL BWP for an uplink communication. Alternatively or additionally, the network node 110 may indicate an active BWP that is associated with both UL and DL communications, such as an active BWP associated with TDD communications. In some aspects, an active BWP indicated by the network node 110 may be configured based at least in part on one or more capabilities associated with the UE 120. To illustrate, the network node 110 may select, as the active BWP, a BWP configured with a 5 MHz bandwidth based at least in part on the UE 120 indicating capabilities associated with an IoT and/or a RedCap device.

As shown by reference number 420, the network node 110 may transmit, and the UE 120 may receive, at least a first reference signal. As one example, the network node 110 may transmit an SSB based at least in part on an initial BWP associated with the network node 110. To illustrate, the network node 110 may transmit a cell-defining SSB. In some aspects, the network node 110 may iteratively and/or periodically transmit a same reference signal and/or combinations of reference signals. Accordingly, although the example 400 shows the network node 110 first transmitting an indication of the active BWP and then transmitting the reference signal, other examples may include the network node 110 first transmitting the reference signal and then transmitting the indication of the active BWP.

As shown by reference number 430, the UE 120 may transmit, and the network node 110 may receive, one or more uplink communications. As one example, the UE 120 may transmit a random access channel (RACH) based at least in part on using the initial BWP. That is, the UE 120 may transmit the RACH based at least in part on using a frequency that is located within the initial BWP. In some aspects, the UE 120 may configure the RACH based at least in part on receiving the reference signal (e.g., the SSB) within the initial BWP. To illustrate, the UE 120 may use a transmission power level that is based at least in part on a received power level associated with the reference signal.

Although the example 400 shows the UE 120 transmitting an uplink communication after receiving the indication of the active BWP and the reference signal, other examples may include the UE 120 receiving the indication of the active BWP, receiving the reference signal, and transmitting an uplink communication in varying orders. As one example, the UE 120 may receive a first reference signal and then transmit an uplink communication (e.g., a RACH or another uplink communication) based at least in part on the first reference signal. The UE 120 may receive the indication of the active BWP after transmitting an uplink communication and/or may receive a second reference signal after receiving the indication of the active BWP.

In some aspects, the UE 120 may transmit multiple uplink communications. For instance, the UE 120 may initially transmit a first uplink communication (e.g., the RACH or the other uplink communication) based at least in part on using the initial BWP, and transmit a second uplink communication based at least in part on using an active BWP (e.g., an active UL BWP or an active BWP associated with TDD communications). To illustrate, the UE 120 may transmit, as the second uplink communication, a physical uplink control channel (PUCCH) or a physical uplink shared channel (PUSCH).

The UE 120 may transmit the second uplink communication based at least in part on receiving an instruction (e.g., from the network node 110). For instance, the UE 120 may receive an instruction that indicates to transmit an uplink communication, such as an instruction to transmit a RACH based at least in part on the active BWP. In some aspects, the UE 120 may transmit the second uplink communication in the active BWP based at least in part on the reference signal (e.g., the SSB) received in the initial BWP. As one example, the UE 120 may transmit the second uplink communication by using a transmission power level that is based at least in part on a received power level associated with the reference signal. Alternatively or additionally, the UE 120 may receive an instruction that indicates to transmit the second uplink communication based at least in part on a target received power level.

As shown by reference number 440, the network node 110 may determine a BWP measurement offset associated with the UE 120. As one example, the network node 110 may determine the BWP measurement offset based at least in part on receiving one or more wireless signals from the UE 120. To illustrate, the network node 110 may calculate a first received power for a first wireless signal from the UE 120 (e.g., a RACH or other uplink communication that is based at least in part on using the initial BWP) and a second received power for a second wireless signal from the UE 120 (e.g., a PUCCH communication and/or a PUSCH communication). In some aspects, the network node 110 may calculate the BWP measurement offset as a difference between the first received power and the second received power. As another example, the network node 110 may calculate the BWP measurement offset based at least in part on receiving a single wireless signal from the UE 120. To illustrate, the network node 110 may calculate a difference between a power level (e.g., a received power level) associated with a wireless signal (e.g., a second RACH that is based at least in part on the active BWP) and a target received power level for the wireless signal. The network node 110 may indicate, prior to receiving the wireless signal, the target received power level in an instruction to the UE 120. In some aspects, the BWP measurement offset may be equal to the calculated difference. The network node 110 may alternatively or additionally calculate a respective BWP measurement offset for multiple measurements. That is, each BWP measurement offset may be associated with a specific (and different) measurement.

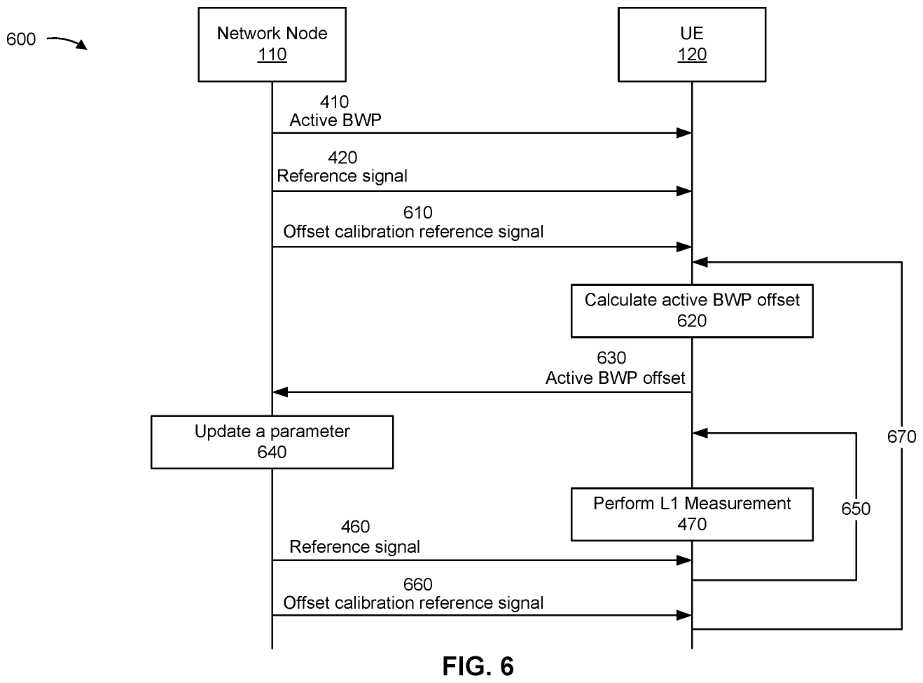

As shown by reference number 450, the network node 110 may transmit, and the UE 120 may receive, an indication of a BWP measurement offset. That is, the network node 110 may transmit an indication of the determined BWP measurement offset as described with regard to reference number 440. In some aspects, the UE 120 may obtain the BWP measurement offset from the network node 110 as shown by the example 400. However, in other examples, such as that described below with regard to FIG. 6, the UE 120 may obtain the BWP measurement offset by calculating the BWP measurement offset. In some aspects, the UE 120 may associate the BWP measurement offset with an L1 measurement and/or an L1 measurement procedure. To illustrate, the UE 120 may use the BWP measurement offset to calibrate the L1 measurement and/or the L1 measurement procedure. Accordingly, the UE 120 may obtain multiple BWP measurements that are associated with multiple measurements.

The network node 110 may transmit the indication of the BWP measurement offset based at least in part on one or more mechanisms. As one example, the network node 110 may transmit the indication of the BWP measurement offset based at least in part on an RRC message (e.g., a field of the RRC message and/or a field of an information element (IE)). Alternatively or additionally, the network node 110 may transmit the indication of the BWP measurement offset based at least in part on downlink control information (DCI) and/or a medium access control (MAC) control element (CE). That is, the network node 110 may transmit an indication of the BWP measurement offset based at least in part on a field and/or bit of the DCI and/or the MAC CE.

As shown by reference number 460, the network node 110 may transmit, and the UE 120 may receive, a reference signal. To illustrate, and similar to the reference signal described with regard to reference number 410, the network node 110 may transmit the reference signal based at least in part on the initial BWP and/or a second, different BWP (e.g., using a frequency indicated by the synchronization raster that is outside of the active BWP). Examples of a reference signal may include an SSB and/or a CSI-RS. In some aspects, the UE 120 may filter the reference signal (e.g., the SSB) based at least in part on a frequency difference between the active BWP and the second BWP and/or the initial BWP. For example, the UE 120 may filter the SSB based at least in part on a time duration, and the time duration may change based at least in part on the frequency difference. To illustrate, the UE 120 may increase a filtering time duration as the frequency difference increases and/or decrease the filtering time duration as the frequency difference decreases. As shown by reference number 470, the UE 120 may perform an L1 measurement and/or an L1 measurement procedure based at least in part on the BWP measurement offset (e.g., a BWP measurement offset that is specific to the L1 measurement and/or L1 measurement procedure). To illustrate, the UE 120 may generate an L1 measurement metric based at least in part on the BWP measurement offset, such as by generating an initial L1 measurement metric (e.g., an L1-RSRP metric) without using the BWP measurement offset, and subsequently generating an updated and/or calibrated L1 measurement metric (e.g., an updated and/or calibrated L1-RSRP metric) by modifying the initial L1 metric with the BWP measurement offset. For instance, the BWP measurement offset may indicate an L1-RSRP difference and the UE 120 may modify the initial L1-RSRP metric by adding or subtracting the L1-RSRP difference to or from the initial L1-RSRP metric. As another example, the UE 120 may modify the initial L1 measurement metric by combining (e.g., adding or subtracting) the initial L1 measurement metric with a portion, ratio, scaled, fraction, and/or percentage of the BWP measurement offset. The UE 120 may calibrate any L1 measurement and/or perform any L1 measurement procedure based at least in part on the BWP measurement offset, such as by using a calibrated L1 measurement metric in a BFD procedure and/or an RLM procedure. To illustrate, the UE 120 may generate, based at least in part on the BWP measurement offset, a calibrated L1 measurement metric that is compared to a threshold in an L1 measurement procedure. Accordingly, the UE 120 may communicate in a wireless network based at least in part on using the BWP measurement offset to calibrate an L1 measurement metric and/or an L1 measurement procedure that may be used to determine a signal configuration and/or to maintain a wireless link.

As shown by reference number 480, the network node 110 may iteratively transmit, and the UE 120 may iteratively receive, a reference signal, such as a reference signal located outside of an active BWP. Alternatively or additionally, as shown by reference number 490, the UE 120 may transmit an uplink communication that results in the network node 110 determining an updated BWP measurement offset. The ability to generate updated BWP measurement offsets enables the network node 110 and the UE 120 to update a calibration metric as channel conditions change, improve a signal quality, and/or reduce false failure detections by an L1 measurement procedure.

As indicated above, FIG. 4 is provided as an example. Other examples may differ from what is described with regard to FIG. 4.

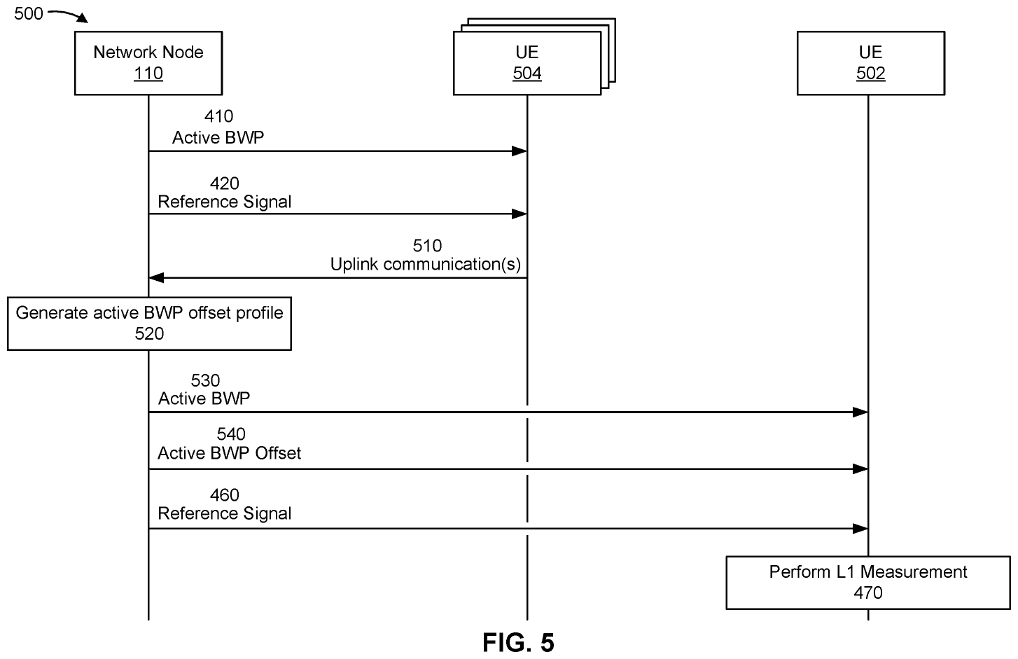

FIG. 5 is a diagram illustrating an example 500 of a wireless communication process between a network node (e.g., the network node 110), a UE 502 (e.g., a UE 120), and one or more other UEs 504 (e.g., one or more other UEs 120), in accordance with the present disclosure.

As shown by reference number 410, and as further described with regard to FIG. 4, a network node 110 may transmit, and one or more other UEs 504 may receive, an indication of an active BWP. To illustrate, the network node 110 may transmit an indication of a respective active BWP to each respective UE of the UEs 504, such as by transmitting the indication of the respective active BWP to a respective UE 504 based at least in part on a unicast message. As shown by reference number 420, and as further described with regard to FIG. 4, the network node 110 may transmit, and the one or more other UEs 504 may receive, at least a first reference signal, such as a cell-defining SSB that is based at least in part on an initial BWP.

As shown by reference number 510, the UE(s) 504 may transmit, and the network node 110 may receive, a respective uplink communication. To illustrate, and as further described with regard to FIG. 4, a UE 504 may transmit a RACH that is based at least in part on the initial BWP and/or a RACH that is based at least in part on the respective active BWP associated with the UE 504. The UE 504 may transmit the RACH based at least in part on a respective target power level indicated by the network node 110. Alternatively or additionally, the UE 504 may transmit, as the uplink communication, a PUCCH transmission and/or a PUSCH transmission.

In some aspects, the UE 504 may transmit, as at least part of the uplink communication, a channel condition metric and/or a measurement report that is based at least in part on a respective active BWP associated with the UE 504. To illustrate, the UE 504 may transmit an RSRP metric, an RSSI metric, an RSRQ metric, and/or a CQI metric that is based at least in part on a downlink communication received using the respective active BWP. Alternatively or additionally, the UE 504 may transmit a channel condition metric and/or a measurement report that is based at least in part on a downlink communication received using the initial BWP. In some aspects, and as further described with regard to FIG. 6, the UE 504 may indicate, to the network node 110, a respective BWP measurement offset associated with a specific measurement.

As shown by reference number 520, the network node 110 may generate a BWP measurement offset profile and/or a channel condition profile. For instance, the network node 110 may generate, based at least in part on the channel condition metric(s) from the UE(s) 504, a channel profile that characterizes a transmission channel at various frequencies. Alternatively or additionally, as further described below with regard to FIG. 6, the network node 110 may generate a BWP measurement offset profile that characterizes the transmission channel at various frequencies. In some aspects, the transmission channel may be based at least in part on a carrier frequency bandwidth that includes the initial BWP and/or each respective active BWP associated with the UE(s) 504.

To illustrate, and as further described above, the network node 110 may receive (e.g., from a first UE 504 of the UE(s) 504) a first channel condition metric associated with a first active BWP assigned to the first UE 504, a second channel condition metric (e.g., from a second UE 504 of the UE(s) 504) associated with a second, different active BWP assigned to the second UE 504, and/or a third channel condition metric (e.g., from a third UE 504 of the UE(s) 504) associated with a third, different active BWP assigned to the third UE 504. That is, each UE 504 may indicate a channel condition metric (e.g., RSRP, RSSI, RSRQ, and/or CQI) associated with a different portion of the transmission channel. The network node 110 may store and/or save each channel condition metric to generate a channel profile that indicates a respective channel condition (e.g., by way of a channel condition metric) for a range of frequencies associated with the channel profile. The network node 100 may store and/or generate multiple channel profiles, and each channel profile may be associated with a respective (and different) measurement.

As shown by reference number 530, the network node 110 may transmit, and a UE 502 may receive, an indication of an active BWP. For example, and similar to the reference signal described with regard to reference number 410 of FIG. 4, the network node may indicate the active BWP to the UE 502 based at least in part on an RRC message, DCI, and/or a MAC CE.

As shown by reference number 540, the network node 110 may transmit, and the UE 502 may receive, an indication of a BWP measurement offset. As one example, the network node 110 may select and/or calculate the BWP measurement offset based at least in part on the channel profile and the active BWP assigned to the UE 502. To illustrate, the network node 110 may identify, from the channel profile, a channel condition at a frequency closest (e.g., relative to other frequencies reported in the channel profile) to the active BWP assigned to the UE 502. As another example, the network node 110 may generate a channel condition metric based at least in part on interpolating two channel condition metrics (e.g., from the channel profile) associated with two frequencies closest to the active BWP assigned to the UE 502. The network node 110 may alternatively or additionally calculate a BWP measurement offset based at least in part on the selected channel condition from the channel profile and/or the generated channel condition. For instance, the network node 110 may calculate the BWP measurement offset based at least in part on calculating a difference between RSRP metrics that are stored as part of the channel profile as further described with regard to reference number 440 of FIG. 4. However, the network node 110 may calculate multiple BWP measurement offsets that are each associated with a respective measurement.

As shown by reference number 460, and as further described with regard to FIG. 4, the network node 110 may transmit, and the UE 502 may receive, a reference signal. To illustrate, the network node 110 may transmit one or more reference signals (e.g., same reference signals and/or different reference signals) based at least in part on the initial BWP and/or a second, different BWP.

As shown by reference number 470, and as further described with regard to FIG. 4, the UE 502 may perform an L1 measurement and/or an L1 measurement procedure based at least in part on the BWP measurement offset (e.g., associated with the L1 measurement and/or the L1 measurement procedure) and/or the reference signal. For instance, the UE 120 may modify an initial L1 measurement metric by combining (e.g., adding or subtracting) the initial L1 measurement metric with the BWP measurement offset and/or a fraction of the BWP measurement offset. Alternatively or additionally, the UE 120 may perform an L1 measurement procedure by generating a calibrated L1 measurement metric, and comparing the calibrated L1 measurement metric to a threshold in an L1 measurement procedure. Accordingly, the UE 120 may communicate in a wireless network based at least in part on using the BWP measurement offset to calibrate an L1 measurement metric and/or an L1 measurement procedure that may be used to determine a signal configuration and/or to maintain a wireless link.

As indicated above, FIG. 5 is provided as an example. Other examples may differ from what is described with regard to FIG. 5.

FIG. 6 is a diagram illustrating an example 600 of a wireless communication process between a network node (e.g., the network node 110) and a UE (e.g., the UE 120), in accordance with the present disclosure.

As shown by reference number 410, and as further described with regard to FIG. 4, a network node 110 may transmit, and a UE 120 may receive, an indication of an active BWP. As shown by reference number 420, and as further described with regard to FIG. 4, the network node 110 may transmit, and the UE 120 may receive, at least a first reference signal, such as a cell-defining SSB that is based at least in part on an initial BWP.

As shown by reference number 610, the network node 110 may transmit, and the UE 120 may receive, an offset calibration reference signal. As one example, the network node 110 may transmit, as the offset calibration reference signal, a non-cell-defining SSB. Alternatively or additionally, the network node 110 may transmit the offset calibration reference signal based at least in part on the active BWP, such as by using a frequency that is within and/or inside the active BWP assigned to the UE 120.

In some aspects, the network node 110 may conditionally transmit the offset calibration reference signal. To illustrate, the network node 110 may transmit the reference signal as described with regard to reference number 420 based at least in part on an initial BWP and/or a second BWP that is different from the active BWP associated with the UE 120. That is, a transmission frequency associated with the reference signal may be located outside of the active BWP associated with the UE 120 (e.g., the transmission frequency may be located within the initial BWP or within the second BWP). In some aspects, the network node 110 may determine that a frequency difference between a first frequency within the active BWP and a second frequency associated with a second BWP (e.g., a BWP that includes the transmission frequency associated with the reference signal) satisfies a frequency difference threshold. The network node may transmit the offset calibration reference signal based at least in part on the frequency difference satisfying the frequency difference threshold and/or refrain from transmitting the offset calibration reference signal based at least in part on the frequency difference failing to satisfy the frequency difference threshold.

As shown by reference number 620, the UE 120 may calculate a BWP measurement offset. That is, the UE 120 may obtain the BWP measurement offset by calculating the BWP measurement offset. In some aspects, the UE 120 may calculate the BWP measurement offset based at least in part on receiving the reference signal as described with regard to reference number 420 and receiving the offset calibration reference signal as described with regard to reference number 610. For instance, the UE 120 may calculate a first signal metric (e.g., RSRP and/or RSSI) based at least in part on the offset calibration reference signal (e.g., a non-cell-defining SSB) and a second signal metric based at least in part on the reference signal (e.g., a cell-defining SSB). The UE 120 may calculate the BWP measurement offset by calculating a difference between the first signal metric and the second signal metric. In some aspects, the BWP measurement offset is the difference between the first signal metric and the second signal metric. The UE 120 may alternatively or additionally calculate multiple BWP measurement offsets that are each associated with a respective measurement.

The UE 120 may conditionally calculate the BWP measurement offset. To illustrate, the UE 120 may determine that a frequency difference between a first frequency within the active BWP and a second frequency within a second BWP (e.g., associated with a reference signal) satisfies a frequency difference threshold. In some aspects, the UE 120 may calculate and/or recalculate the BWP measurement offset, the first signal metric, and/or the second signal metric based at least in part on determining that the frequency difference satisfies the frequency difference threshold.

As shown by reference number 630, the UE 120 may transmit, and the network node 110 may receive, an indication of the BWP measurement offset calculated by the UE 120. For instance, the UE 120 may transmit the indication of the BWP measurement offset based at least in part on an RRC message and/or as part of a measurement report. In some aspects, the UE 120 may transmit indication(s) of multiple BWP measurement offsets.

As shown by reference number 640, the network node 110 may update one or more parameters based at least in part on the BWP measurement offset. As one example, the network node 110 may update and/or calculate a UE-specific threshold using the BWP measurement offset, such as a UE-specific threshold that is associated with an L1 measurement and/or an L1 measurement procedure. To illustrate, the network node 110 may calculate a radio link failure threshold (e.g., for an RLM procedure), an RSRP threshold, an RSRQ threshold, and/or a BFD threshold.

In some aspects, the network node 110 may assign (and/or refrain from assigning) an air interface resource based at least in part on the BWP measurement offset. To illustrate, a first BWP measurement offset may indicate that a difference between a first channel condition associated with a first frequency (e.g., within the active BWP) and a second channel condition associated with a second frequency (e.g., within an initial BWP) satisfies an error threshold. The network node 110 may subsequently avoid assigning an air interface resource associated with the first frequency. Alternatively or additionally, the network node 110 may assign the air interface resource associated with the first frequency based at least in part on the difference failing to satisfy the error threshold. The network node 110 may indicate the UE-specific threshold and/or the resource assignment to the UE 120.

In some aspects, the network node 110 may generate and/or update a BWP measurement offset profile that associates one or more BWP measurement offsets with a transmission channel, as further described with regard to FIG. 5. For example, the network node 110 may generate and/or update the BWP measurement offset profile based at least in part on receiving multiple BWP measurement offsets associated with multiple frequencies of the transmission channel.

The network node 110 may calculate and/or derive a first BWP measurement offset based at least in part on a second BWP measurement offset, such as a BWP measurement offset for another UE that lacks a capability to generate and/or calculate a BWP measurement offset. To illustrate, the network node 110 may identify, from the BWP measurement offset profile, a BWP measurement offset at a frequency closest (e.g., relative to other frequencies reported in the BWP measurement offset profile) to another active BWP assigned to the other UE. As another example, the network node 110 may generate a BWP measurement offset based at least in part on interpolating two BWP measurement offsets associated with at least two frequencies closest to the other active BWP assigned to the other UE.

As shown by reference number 470, and as further described with reference to FIG. 4, the UE 120 may perform an L1 measurement and/or an L1 measurement procedure based at least in part on a reference signal and/or the BWP measurement offset. As one example, the UE 120 may perform the L1 measurement based at least in part on the reference signal described with regard to reference number 420. Alternatively or additionally, the UE 120 may perform an L1 measurement procedure based at least in part on receiving a UE-specific threshold (e.g., generated by the network node 110 using the BWP measurement offset) and/or by using a calibrated L1 measurement metric.

As shown by reference number 460, and as further described with regard to FIG. 4, the network node 110 may transmit, and the UE 120 may receive, one or more other reference signals. Alternatively or additionally, and as shown by reference number 650, the UE 120 may iteratively perform an L1 measurement based at least in part on the reference signal. In some aspects, the network node 110 may iteratively transmit the reference signal based at least in part on a first periodicity. For example, the network node 110 may transmit a cell-defining SSB based at least in part on the first periodicity and the UE 120 may iteratively generate an L1-RSRP metric based at least in part on the cell-defining SSB.

As shown by reference number 660, and as further described with regard to reference number 610, the network node 110 may transmit, and the UE 120 may receive, an offset calibration reference signal. Alternatively or additionally, and as shown by reference number 670, the UE 120 may iteratively calculate a BWP measurement offset based at least in part on iteratively receiving the offset calibration reference signal within the active BWP. In some aspects, the network node 110 may transmit the offset calibration reference signal based at least in part on a second periodicity that is longer than the first periodicity. That is, the network node 110 may transmit the offset calibration reference signal (e.g., a non-cell-defining SSB within the active BWP) less often than the reference signal (e.g., a cell-defining SSB outside of the active BWP).

A BWP measurement offset may improve an accuracy of an L1 measurement and/or an L1 measurement procedure performed by a UE. The improved accuracy may reduce false failure detections by the L1 measurement procedure and/or enable a network node to select a transmission configuration that results in reduced recovery errors, increased data throughput, and/or reduced data transfer latencies relative to a second transmission configuration.

As indicated above, FIG. 6 is provided as an example. Other examples may differ from what is described with regard to FIG. 6.

FIG. 7 is a diagram illustrating an example process 700 performed, for example, by a network node, in accordance with the present disclosure. Example process 700 is an example where the network node (e.g., network node 110) performs operations associated with calibration of an L1 measurement outside of an active bandwidth part.

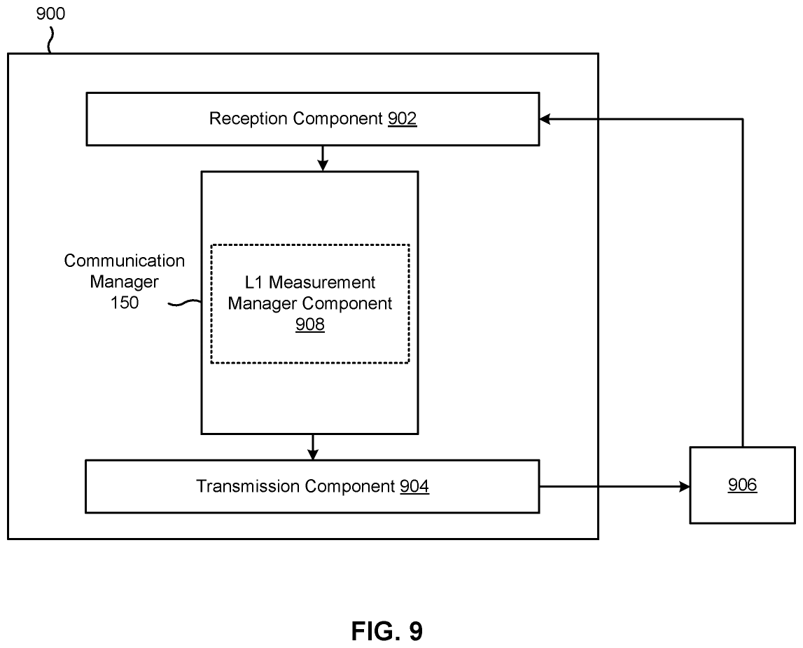

As shown in FIG. 7, in some aspects, process 700 may include determining a BWP measurement offset associated with an L1 measurement (block 710). For example, the network node (e.g., using communication manager 150 and/or an L1 measurement manager component 908, depicted in FIG. 9) may determine a BWP measurement offset associated with an L1 measurement, as described above. In some aspects, the network node may determine multiple BWP measurement offsets that are each associated with a respective measurement.

As further shown in FIG. 7, in some aspects, process 700 may include transmitting an indication of the BWP measurement offset (block 720). For example, the network node (e.g., using communication manager 150 and/or transmission component 904, depicted in FIG. 9) may transmit an indication of the BWP measurement offset, as described above.

Process 700 may include additional aspects, such as any single aspect or any combination of aspects described below and/or in connection with one or more other processes described elsewhere herein.

In a first aspect, transmitting the indication of the BWP measurement offset includes transmitting the indication based at least in part on at least one of a radio resource control message, downlinking control information, or a MAC CE.

In a second aspect, process 700 includes receiving a wireless signal from a UE, and determining the BWP measurement offset is based at least in part on the wireless signal.

In a third aspect, transmitting the indication of the BWP measurement offset includes transmitting the indication to the UE.

In a fourth aspect, receiving the wireless signal includes receiving the wireless signal based at least in part on using an initial BWP.

In a fifth aspect, the wireless signal is based at least in part on a RACH.

In a sixth aspect, the initial BWP is associated with an SSB.

In a seventh aspect, the SSB is a cell-defining SSB.

In an eighth aspect, the wireless signal is a first wireless signal, and process 700 includes receiving a second wireless signal based at least in part on using the active BWP.

In a ninth aspect, process 700 includes calculating a difference between the first wireless signal and the second wireless signal, and determining the BWP measurement offset is based at least in part on the difference.

In a tenth aspect, calculating the difference includes calculating a difference between a first received power associated with the first wireless signal and a second received power associated with the second wireless signal.

In an eleventh aspect, the second wireless signal is based at least in part on at least one of a physical uplink control channel transmission, or a physical uplink shared channel transmission.

In a twelfth aspect, process 700 includes transmitting an instruction to the UE that indicates to transmit, as the wireless signal, an uplink wireless signal in an active BWP, and receiving the wireless signal includes receiving the uplink wireless signal based at least in part on using the active BWP.

In a thirteenth aspect, the instruction indicates to transmit the wireless signal based at least in part on a RACH.

In a fourteenth aspect, the instruction further indicates a target received power level.

In a fifteenth aspect, a transmitted power associated with the uplink wireless signal is derived from an SSB received outside of the active BWP In a sixteenth aspect, process 700 includes calculating a difference between the transmitted power associated with the uplink wireless signal and the target received power level, and determining the BWP measurement offset is based at least in part on the difference.

In a seventeenth aspect, process 700 includes receiving a channel condition metric from a UE, and determining the BWP measurement offset is based at least in part on the channel condition metric.

In an eighteenth aspect, the UE is a first UE, and transmitting the indication of the BWP measurement offset includes transmitting the indication to a second UE.

In a nineteenth aspect, process 700 includes generating, based at least in part on the channel condition metric, a channel profile that characterizes a transmission channel, the transmission channel is based at least in part on the active BWP and a second BWP that is outside of the active BWP, and determining the BWP measurement offset is based at least in part on the channel profile.

In a twentieth aspect, the channel condition metric is based at least in part on the active BWP.

In a twenty-first aspect, the channel condition metric is based at least in part on the second BWP.

In a twenty-second aspect, the channel condition metric comprises reference signal received power.

In a twenty-third aspect, the indication of the BWP measurement offset is a first indication of a first BWP measurement offset, and process 700 includes receiving a second indication of a second BWP measurement offset from a UE, and calculating the first BWP measurement offset based at least in part on the second BWP measurement offset.

In a twenty-fourth aspect, process 700 includes generating, based at least in part on the second BWP measurement offset, a BWP measurement offset profile that associates one or more BWP measurement offsets with a transmission channel, the transmission channel is based at least in part on the active BWP and a second BWP that is outside of the active BWP, and determining the BWP measurement offset is based at least in part on the BWP measurement offset profile.

In a twenty-fifth aspect, process 700 includes transmitting an offset calibration reference signal within the active BWP, and transmitting a second reference signal in a second BWP that is outside of the active BWP.

In a twenty-sixth aspect, process 700 includes determining that a frequency difference between a first frequency within the active BWP and a second frequency within the second BWP satisfies a frequency difference threshold, and transmitting the offset calibration reference signal is based at least in part on determining that the frequency difference satisfies the frequency difference threshold.

In a twenty-seventh aspect, transmitting the offset calibration reference signal includes transmitting the offset calibration reference signal based at least in part on a transmission periodicity.

In a twenty-eighth aspect, the transmission periodicity is a first transmission periodicity, transmitting the second reference signal includes transmitting the second reference signal based at least in part on a second transmission periodicity, and the first transmission periodicity is longer than the second transmission periodicity.

In a twenty-ninth aspect, process 700 includes receiving a BWP measurement offset from a first UE, calculating a UE-specific threshold based at least in part on the BWP measurement offset, and transmitting the UE-specific threshold to the first UE or a second UE that is different from the first UE.

In a thirtieth aspect, the UE-specific threshold includes at least one of a radio link failure threshold, a reference signal received power threshold, a reference signal received quality threshold, or a beam failure detection threshold.

In a thirty-first aspect, process 700 includes assigning an air interface resource based at least in part on the BWP measurement offset.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with calibration of an L1 measurement outside of an active bandwidth part.

As shown in FIG. 8, in some aspects, process 800 may include obtaining an indication of a BWP measurement offset associated with an L1 measurement (block 810). For example, the UE (e.g., using communication manager 140 and/or an L1 measurement manager component 1008, depicted in FIG. 8) may obtain an indication of a BWP measurement offset associated with an L1 measurement, as described above. The UE may obtain indication(s) of multiple BWP measurement offsets that are each associated with a respective (different) measurement.

As further shown in FIG. 8, in some aspects, process 800 may include communicating in a wireless network based at least in part on using the BWP measurement offset with the layer 1 measurement (block 820). For example, the UE (e.g., using communication manager 140 and/or the L1 measurement manager component 1008, depicted in FIG. 8) may communicate in a wireless network based at least in part on using the BWP measurement offset with the layer 1 measurement, as described above.

Process 800 may include additional aspects, such as any single aspect or any combination of aspects described below and/or in connection with one or more other processes described elsewhere herein.

In a first aspect, obtaining the indication of the BWP measurement offset includes obtaining the indication from a network node and based at least in part on at least one of a radio resource control message, downlinking control information, or a MAC CE.

In a second aspect, process 800 includes receiving an SSB in an initial BWP, transmitting a RACH in the initial BWP based at least in part on the SSB, and transmitting an uplink transmission in an active BWP based at least in part on receiving the SSB in the initial BWP, the BWP measurement offset is based at least in part on the uplink transmission, and obtaining the indication of the BWP measurement offset includes receiving the indication of the BWP measurement offset from a network node.

In a third aspect, the uplink transmission is based at least in part on at least one of a physical uplink control channel, or a physical uplink shared channel.

In a fourth aspect, the SSB is a cell-defining SSB.

In a fifth aspect, process 800 includes receiving an SSB in an initial BWP that is outside of an active BWP, receiving an instruction that indicates to transmit a RACH in an active BWP, and transmitting the RACH in the active BWP based at least in part on receiving the SSB in the initial BWP.

In a sixth aspect, the instruction further indicates a target received power level.

In a seventh aspect, transmitting the RACH includes transmitting the RACH based at least in part on a power level associated with the SSB.

In an eighth aspect, obtaining the BWP measurement offset includes receiving an SSB based at least in part on using a second BWP that is outside of an active BWP, receiving an offset calibration reference signal based at least in part on using the active BWP, and calculating the BWP measurement offset based at least in part on receiving the SSB and the offset calibration reference signal.

In a ninth aspect, process 800 includes calculating a first signal metric based at least in part on the offset calibration reference signal, calculating a second signal metric based at least in part on the SSB, and calculating a difference between the first signal metric and the second signal metric. In some aspects, calculating the BWP measurement offset includes calculating the BWP measurement offset based at least in part on the difference.

In a tenth aspect, process 800 includes determining that a frequency difference between a first frequency within the active BWP and a second frequency within the second BWP satisfies a frequency difference threshold, and calculating the BWP measurement offset is based at least in part on determining that the frequency difference satisfies the frequency difference threshold.

In an eleventh aspect, receiving the offset calibration reference signal includes receiving the offset calibration reference signal based at least in part on a transmission periodicity.

In a twelfth aspect, the transmission periodicity is a first transmission periodicity, receiving the SSB includes receiving the SSB based at least in part on a second transmission periodicity, and the first transmission periodicity is longer than the second transmission periodicity.

In a thirteenth aspect, the offset calibration reference signal includes a non-cell-defining SSB.

In a fourteenth aspect, process 800 includes transmitting the BWP measurement offset to a network node, and receiving a UE-specific threshold that is based at least in part on the active BWP. In some aspects, communicating in the wireless network based at least in part on using the BWP measurement offset with the layer 1 measurement includes using the UE-specific threshold in an L1 measurement procedure associated with the layer 1 measurement.

In a fifteenth aspect, the UE-specific threshold includes at least one of a radio link failure threshold, a reference signal received power threshold, a reference signal received quality threshold, or a beam failure detection threshold.

In a sixteenth aspect, transmitting the BWP measurement offset is in addition to transmitting a measurement report.

In a seventeenth aspect, the layer 1 measurement is based at least in part on at least one of a beam failure detection procedure, a radio link monitoring procedure, or a layer 1 reference signal received power procedure.

In an eighteenth aspect, process 800 includes generating an L1 measurement metric based at least in part on the BWP measurement offset.

In a nineteenth aspect, the layer 1 measurement metric is an updated layer 1 measurement metric, generating the layer 1 measurement metric includes generating an initial layer 1 measurement metric without using the BWP measurement offset, and generating the updated layer 1 measurement metric includes modifying the initial layer 1 measurement metric based at least in part on the BWP measurement offset.

In a twentieth aspect, modifying the initial layer 1 measurement metric includes combining the initial layer 1 measurement metric with a fraction of the BWP measurement offset.

In a twenty-first aspect, process 800 includes receiving an SSB based at least in part on using a second BWP that is outside of an active BWP, and filtering the SSB based at least in part on a time duration that is based at least in part on a frequency difference between the second BWP and the active BWP.

In a twenty-second aspect, the time duration increases as the frequency difference increases.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of an L1 measurement manager component 908, among other examples.

In some aspects, the apparatus 900 may be configured to perform one or more operations described herein in connection with FIGS. 4-8. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The L1 measurement manager component 908 may determine a BWP measurement offset associated with an L1 measurement. The L1 measurement manager component 908 may transmit, by way of the transmission component 904, an indication of the BWP measurement offset. In some aspects, the transmission component 904 may transmit the indication of the BWP measurement offset to a UE.

The reception component 902 may receive a wireless signal from a UE and the L1 measurement manager component 908 may determine the BWP measurement offset based at least in part on the wireless signal. In some aspects, the L1 measurement manager component 908 may calculate a difference between the first wireless signal and the second wireless signal and determine the BWP measurement offset based at least in part on the difference. The L1 measurement manager component 908 may transmit, by way of the transmission component 904, an instruction to the UE that indicates to transmit the wireless signal in an active BWP. The L1 measurement manager component 908 may calculate a difference between a power level associated with the wireless signal and the target received power level, and determine the BWP measurement offset based at least in part on the difference.

The reception component 902 may receive a channel condition metric from a UE, and the L1 measurement manager component 908 may determine the BWP measurement offset based at least in part on the channel condition metric. The L1 measurement manager component 908 may generate, based at least in part on the channel condition metric, a channel profile that characterizes a transmission channel that is based at least in part on an active BWP and a second BWP that is outside of the active BWP, and determine the BWP measurement offset based at least in part on the channel profile. In some aspects, the L1 measurement manager component 908 may generate, based at least in part on the second BWP measurement offset, a BWP measurement offset profile that associates one or more BWP measurement offsets with a transmission channel that is based at least in part on the active BWP and the second BWP that is outside of the active BWP, and determine the BWP measurement offset based at least in part on the BWP measurement offset profile.

The L1 measurement manager component 908 may transmit, by way of the transmission component 904, an offset calibration reference signal within the active BWP. Alternatively or additionally, the transmission component 904 may transmit a second reference signal in a second BWP that is outside of an active BWP. In some aspects, the L1 measurement manager component 908 may determine that a frequency difference between a first frequency within the active BWP and a second frequency within the second BWP satisfies a frequency difference threshold, and transmit, by way of the transmission component 904, the offset calibration reference signal based at least in part on determining that the frequency difference satisfies the frequency difference threshold.

The L1 measurement manager component 908 may receive, by way of the reception component 902, a BWP measurement offset from a first UE. Alternatively or additionally, the L1 measurement manager component 908 may calculate a UE-specific threshold based at least in part on the BWP measurement offset and transmit, by way of the transmission component 904, the UE-specific threshold to the first UE or to a second UE that is different from the first UE. In some aspects, the L1 measurement manager component 908 may assign an air interface resource based at least in part on the BWP measurement offset

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

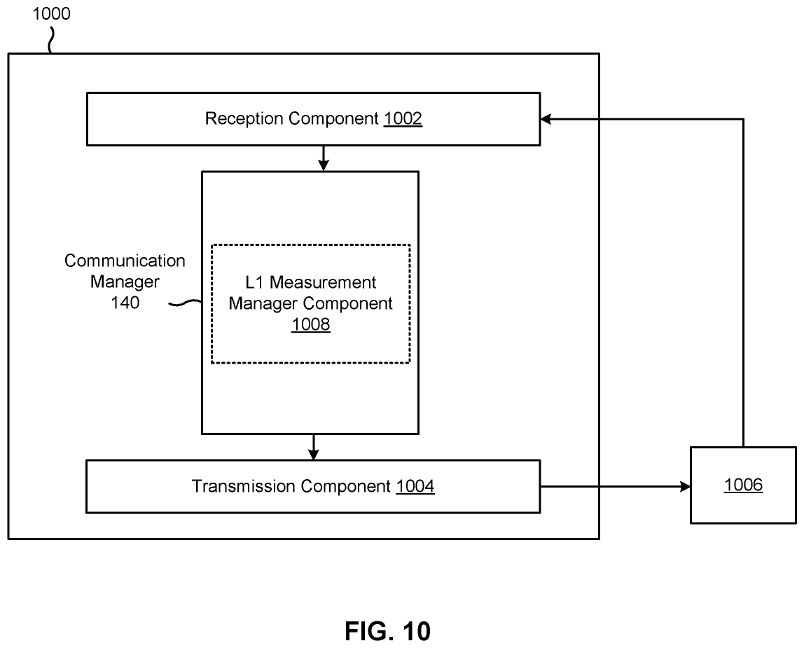

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an L1 measurement manager component 1008, among other examples.

In some aspects, the apparatus 1000 may be configured to perform one or more operations described herein in connection with FIGS. 4-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The L1 measurement manager component 1008 may obtain an indication of a BWP measurement offset associated with an L1 measurement. The L1 measurement manager component 1008 may communicate in a wireless network based at least in part on using the BWP measurement offset with the layer 1 measurement.

The L1 measurement manager component 1008 may receive, by way of the reception component 1002, an SSB in an initial BWP. In some aspects, the L1 measurement manager component 1008 may transmit, by way of the transmission component 1004, a RACH in the initial BWP based at least in part on the SSB.

The L1 measurement manager component 1008 may transmit, by way of the transmission component 1004, an uplink transmission in an active BWP based at least in part on receiving the SSB in the initial BWP. In some aspects, the BWP measurement offset is based at least in part on the uplink transmission.

The reception component 1002 may receive an SSB in an initial BWP that is outside of an active BWP. Alternatively or additionally, the L1 measurement manager component 1008 may receive, by way of the reception component 1002, an instruction that indicates to transmit a RACH in the active BWP. The L1 measurement manager component 1008 may transmit, by way of the transmission component 1004, the RACH in the active BWP based at least in part on receiving the SSB in the initial BWP.

The L1 measurement manager component 1008 may calculate a first signal metric based at least in part on the offset calibration reference signal. Alternatively or additionally, the L1 measurement manager component 1008 may calculate a second signal metric based at least in part on the SSB. The L1 measurement manager component 1008 may calculate a difference between the first signal metric and the second signal metric and determine that a frequency difference between a first frequency within the active BWP and a second frequency within the second BWP satisfies a frequency difference threshold. In some aspects, the L1 measurement manager component 1008 may calculate the BWP measurement offset based at least in part on determining that the frequency difference satisfies the frequency difference threshold.

The L1 measurement manager component 1008 may transmit, by way of the transmission component 1004, the BWP measurement offset to a network node. Alternatively or additionally, the L1 measurement manager component 1008 may receive, by way of the reception component 1002, a UE-specific threshold that is based at least in part on an active BWP. In some aspects, the L1 measurement manager component 1008 may generate an L1 measurement metric based at least in part on the BWP measurement offset.

The reception component 1002 may receive an SSB based at least in part on using a second BWP that is outside of an active BWP. In some aspects, the L1 measurement manager component 1008 may filter the SSB based at least in part on a time duration that is based at least in part on a frequency difference between the second BWP and the active BWP.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: determining a bandwidth part (BWP) measurement offset associated with a layer 1 measurement; and transmitting an indication of the BWP measurement offset.

Aspect 2: The method of Aspect 1, wherein transmitting the indication of the BWP measurement offset further comprises: transmitting the indication based at least in part on at least one of: a radio resource control message, downlink control information, or a medium access control (MAC) control element (CE).

Aspect 3: The method of Aspect 1 or Aspect 2, further comprising: receiving a wireless signal from a user equipment (UE), wherein determining the BWP measurement offset is based at least in part on the wireless signal.

Aspect 4: The method of Aspect 3, wherein transmitting the indication of the BWP measurement offset comprises: transmitting the indication to the UE.

Aspect 5: The method of Aspect 3 or Aspect 4, wherein receiving the wireless signal comprises: receiving the wireless signal based at least in part on using an initial BWP.

Aspect 6: The method of Aspect 5, wherein the wireless signal is based at least in part on a random access channel.

Aspect 7: The method of Aspect 5 or Aspect 6, wherein the initial BWP is associated with a synchronization signal block (SSB).

Aspect 8: The method of Aspect 7, wherein the SSB is a cell-defining SSB.

Aspect 9: The method of any one of Aspects 5-8, wherein the wireless signal is a first wireless signal, and the method further comprises: receiving a second wireless signal based at least in part on using an active BWP.

Aspect 10: The method of Aspect 9, further comprising: calculating a difference between the first wireless signal and the second wireless signal, wherein determining the BWP measurement offset is based at least in part on the difference.

Aspect 11: The method of Aspect 10, wherein calculating the difference comprises: calculating a difference between a first received power associated with the first wireless signal and a second received power associated with the second wireless signal.

Aspect 12: The method of any one of Aspects 9-11, wherein the second wireless signal is based at least in part on at least one of: a physical uplink control channel transmission, or a physical uplink shared channel transmission.

Aspect 13: The method of any one of Aspects 3-12, further comprising: transmitting an instruction to the UE that indicates to transmit, as the wireless signal, an uplink wireless signal in an active BWP, and wherein receiving the wireless signal comprises: receiving the uplink wireless signal based at least in part on using the active BWP.

Aspect 14: The method of Aspect 13, wherein the instruction indicates to transmit the wireless signal based at least in part on a random access channel.

Aspect 15: The method of Aspect 14, wherein the instruction further indicates a target received power level.

Aspect 16: The method of Aspect 15, wherein a transmitted power associated with the uplink wireless signal is derived from a synchronization signal block (SSB) received outside of the active BWP.

Aspect 17: The method of Aspect 15 or Aspect 16, further comprising: calculating a difference between a transmitted power associated with the uplink wireless signal and the target received power level, wherein determining the BWP measurement offset is based at least in part on the difference.

Aspect 18: The method of any one of Aspects 1-17, further comprising: receiving a channel condition metric from a user equipment (UE), wherein determining the BWP measurement offset is based at least in part on the channel condition metric.

Aspect 19: The method of Aspect 18, wherein the UE is a first UE, and wherein transmitting the indication of the BWP measurement offset comprises: transmitting the indication to a second UE.

Aspect 20: The method of Aspect 19, further comprising: generating, based at least in part on the channel condition metric, a channel profile that characterizes a transmission channel, wherein the transmission channel is based at least in part on an active BWP and a second BWP that is outside of the active BWP, and wherein determining the BWP measurement offset is based at least in part on the channel profile.

Aspect 21: The method of Aspect 20, wherein the channel condition metric is based at least in part on the active BWP.

Aspect 22: The method of Aspect 20, wherein the channel condition metric is based at least in part on the second BWP.

Aspect 23: The method of Aspect 20, wherein the channel condition metric comprises reference signal received power.

Aspect 24: The method of any one of Aspects 1-23, wherein the indication of the BWP measurement offset is a first indication of a first BWP measurement offset, and the method further comprises: receiving a second indication of a second BWP measurement offset from a user equipment (UE); and calculating the first BWP measurement offset based at least in part on the second BWP measurement offset.

Aspect 25: The method of Aspect 24, further comprising: generating, based at least in part on the second BWP measurement offset, a BWP measurement offset profile that associates one or more BWP measurement offsets with a transmission channel, the transmission channel being based at least in part on an active BWP and a second BWP that is outside of the active BWP, wherein determining the first BWP measurement offset is based at least in part on the BWP measurement offset profile.

Aspect 26: The method of any one of Aspects 1-25, further comprising: transmitting an offset calibration reference signal within an active BWP; and transmitting a second reference signal in a second BWP that is outside of the active BWP.

Aspect 27: The method of Aspect 26, further comprising: determining that a frequency difference between a first frequency within the active BWP and a second frequency within the second BWP satisfies a frequency difference threshold, wherein transmitting the offset calibration reference signal is based at least in part on determining that the frequency difference satisfies the frequency difference threshold.

Aspect 28: The method of Aspect 26 or Aspect 27, wherein transmitting the offset calibration reference signal comprises: transmitting the offset calibration reference signal based at least in part on a transmission periodicity.

Aspect 29: The method of Aspect 28, wherein the transmission periodicity is a first transmission periodicity, wherein transmitting the second reference signal comprises transmitting the second reference signal based at least in part on a second transmission periodicity, and wherein the first transmission periodicity is longer than the second transmission periodicity.

Aspect 30: The method of any one of Aspects 26-29, further comprising: receiving a BWP measurement offset from a first user equipment (UE); calculating a UE-specific threshold based at least in part on the BWP measurement offset; and transmitting the UE-specific threshold to the first UE or a second UE that is different from the first UE.

Aspect 31: The method of Aspect 30, wherein the UE-specific threshold comprises at least one of: a radio link failure threshold, a reference signal received power threshold, a reference signal received quality threshold, or a beam failure detection threshold.

Aspect 32: The method of Aspect 30 or Aspect 31, further comprising: assigning an air interface resource based at least in part on the BWP measurement offset.

Aspect 33: A method of wireless communication performed by a user equipment (UE), comprising: obtaining an indication of a bandwidth part (BWP) measurement offset associated with a layer 1 measurement; and communicating in a wireless network based at least in part on using the BWP measurement offset in the layer 1 measurement.

Aspect 34: The method of Aspect 33, wherein obtaining the indication of the BWP measurement offset further comprises: obtaining the indication from a network node and based at least in part on at least one of: a radio resource control message, downlink control information, or a medium access control (MAC) control element (CE).

Aspect 35: The method of Aspect 33 or Aspect 34, further comprising: receiving a synchronization signal block (SSB) in an initial BWP; transmitting a random access channel in the initial BWP based at least in part on the SSB; and transmitting an uplink transmission in an active BWP based at least in part on receiving the SSB in the initial BWP, wherein the BWP measurement offset is based at least in part on the uplink transmission.

Aspect 36: The method of Aspect 35, wherein the uplink transmission is based at least in part on at least one of: a physical uplink control channel, or a physical uplink shared channel.

Aspect 37: The method of Aspect 35 or Aspect 36, wherein the SSB is a cell-defining SSB.

Aspect 38: The method of any one of Aspects 33-37, further comprising: receiving a synchronization signal block (SSB) in an initial BWP that is outside of an active BWP; receiving an instruction that indicates to transmit a random access channel in the active BWP; and transmitting the random access channel in the active BWP based at least in part on receiving the SSB in the initial BWP.

Aspect 39: The method of Aspect 38, wherein the instruction further indicates a target received power level.

Aspect 40: The method of Aspect 38, wherein transmitting the random access channel comprises: transmitting the random access channel based at least in part on a power level associated with the SSB.

Aspect 41: The method of Aspect 33, wherein obtaining the BWP measurement offset further comprises: receiving a synchronization signal block (SSB) based at least in part on using a second BWP that is outside of an active BWP; receiving an offset calibration reference signal based at least in part on using the active BWP; and calculating the BWP measurement offset based at least in part on receiving the SSB and the offset calibration reference signal.

Aspect 42: The method of Aspect 41, further comprising: calculating a first signal metric based at least in part on the offset calibration reference signal; calculating a second signal metric based at least in part on the SSB; and calculating a difference between the first signal metric and the second signal metric, wherein calculating the BWP measurement offset further comprises: calculating the BWP measurement offset based at least in part on the difference.

Aspect 43: The method of Aspect 42, further comprising: determining that a frequency difference between a first frequency within the active BWP and a second frequency within the second BWP satisfies a frequency difference threshold, wherein calculating the BWP measurement offset is based at least in part on determining that the frequency difference satisfies the frequency difference threshold.

Aspect 44: The method of any one of Aspects 41-43, wherein receiving the offset calibration reference signal comprises: receiving the offset calibration reference signal based at least in part on a transmission periodicity.

Aspect 45: The method of Aspect 44, wherein the transmission periodicity is a first transmission periodicity, wherein receiving the SSB comprises receiving the SSB based at least in part on a second transmission periodicity, and wherein the first transmission periodicity is longer than the second transmission periodicity.

Aspect 46: The method of any one of Aspects 41-45, wherein the offset calibration reference signal comprises a non-cell-defining SSB.

Aspect 47: The method of any one of Aspects 41-46, further comprising: transmitting the BWP measurement offset to a network node; and receiving a UE-specific threshold that is based at least in part on the active BWP, wherein communicating in the wireless network based at least in part on using the BWP measurement offset with the layer 1 measurement further comprises: using the UE-specific threshold in the layer 1 measurement.

Aspect 48: The method of Aspect 47, wherein the UE-specific threshold comprises at least one of: a radio link failure threshold, a reference signal received power threshold, a reference signal received quality threshold, or a beam failure detection threshold.

Aspect 49: The method of Aspect 47 or Aspect 48, wherein transmitting the BWP measurement offset is in addition to transmitting a measurement report.

Aspect 50: The method of any one of Aspects 33-49, wherein the layer 1 measurement is based at least in part on at least one of: a beam failure detection procedure, a radio link monitoring procedure, or a layer 1 reference signal received power procedure.

Aspect 51: The method of any one of Aspects 33-50, further comprising: generating a layer 1 measurement metric based at least in part on the BWP measurement offset.

Aspect 52: The method of Aspect 51, wherein the layer 1 measurement metric is an updated layer 1 measurement metric, and wherein generating the layer 1 measurement metric further comprises: generating an initial layer 1 measurement metric without using the BWP measurement offset; and generating the updated layer 1 measurement metric by modifying the initial layer 1 measurement metric based at least in part on the BWP measurement offset.

Aspect 53: The method of Aspect 52, wherein modifying the initial layer 1 measurement metric further comprises: combining the initial layer 1 measurement metric with a fraction of the BWP measurement offset.

Aspect 54: The method of any one of Aspects 33-53, further comprising: receiving a synchronization signal block (SSB) based at least in part on using a second BWP that is outside of an active BWP; and filtering the SSB based at least in part on a time duration that is based at least in part on a frequency difference between the second BWP and the active BWP.

Aspect 55: The method of Aspect 54, wherein the time duration increases as the frequency difference increases.

Aspect 56: An apparatus for wireless communication at a device, comprising a processor; memory coupled with the processor; and instructions stored in the memory and executable by the processor to cause the apparatus to perform the method of one or more of Aspects 1-32.

Aspect 57: An apparatus for wireless communication at a device, comprising a processor; memory coupled with the processor; and instructions stored in the memory and executable by the processor to cause the apparatus to perform the method of one or more of Aspects 33-55.

Aspect 58: A device for wireless communication, comprising a memory and one or more processors coupled to the memory, the one or more processors configured to perform the method of one or more of Aspects 1-32.

Aspect 59: A device for wireless communication, comprising a memory and one or more processors coupled to the memory, the one or more processors configured to perform the method of one or more of Aspects 33-55.

Aspect 60: An apparatus for wireless communication, comprising at least one means for performing the method of one or more of Aspects 1-32.

Aspect 61: An apparatus for wireless communication, comprising at least one means for performing the method of one or more of Aspects 33-55.

Aspect 62: A non-transitory computer-readable medium storing code for wireless communication, the code comprising instructions executable by a processor to perform the method of one or more of Aspects 1-32.

Aspect 63: A non-transitory computer-readable medium storing code for wireless communication, the code comprising instructions executable by a processor to perform the method of one or more of Aspects 33-55.

Aspect 64: A non-transitory computer-readable medium storing a set of instructions for wireless communication, the set of instructions comprising one or more instructions that, when executed by one or more processors of a device, cause the device to perform the method of one or more of Aspects 1-32.

Aspect 65: A non-transitory computer-readable medium storing a set of instructions for wireless communication, the set of instructions comprising one or more instructions that, when executed by one or more processors of a device, cause the device to perform the method of one or more of Aspects 33-55.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
a memory; and
one or more processors, coupled to the memory, configured to:
determine a bandwidth part (BWP) measurement offset associated with a layer measurement; and
transmit an indication of the BWP measurement offset.

2. The apparatus of claim 1, wherein the one or more processors are further configured to:
receive a wireless signal from a user equipment (UE),
wherein determining the BWP measurement offset is based at least in part on the wireless signal.

3. The apparatus of claim 2, wherein the one or more processors, to receive the wireless signal, are configured to:
receive the wireless signal based at least in part on using an initial BWP.

4. The apparatus of claim 3, wherein the one or more processors are further configured to:
receive a second wireless signal based at least in part on using an active BWP.

5. The apparatus of claim 4, wherein the wireless signal is a first wireless signal, and the one or more processors are further configured to:
calculate a difference between the first wireless signal and the second wireless signal,
wherein the BWP measurement offset is based at least in part on the difference.

6. The apparatus of claim 5, wherein the one or more processors, to calculate the difference, are configured to:
calculate a difference between a first received power associated with the first wireless signal and a second received power associated with the second wireless signal.

7. The apparatus of claim 2, wherein the one or more processors are further configured to:
transmit an instruction to the UE that indicates to transmit, as the wireless signal, an uplink wireless signal in an active BWP, and
wherein the one or more processors, to receive the wireless signal, are configured to:
receive the uplink wireless signal based at least in part on using the active BWP.

8. The apparatus of claim 7, wherein the one or more processors are configured to:
calculate a difference between a transmitted power associated with the uplink wireless signal and a target received power level, and
determine the BWP measurement offset based at least in part on the difference.

9. The apparatus of claim 1, wherein the one or more processors are further configured to:
receive a channel condition metric from a user equipment (UE), and
determine the BWP measurement offset based at least in part on the channel condition metric.

10. The apparatus of claim 1, wherein the indication of the BWP measurement offset is a first indication of a first BWP measurement offset, and wherein the one or more processors are further configured to:
receive a second indication of a second BWP measurement offset from a user equipment (UE); and
calculate the first BWP measurement offset based at least in part on the second BWP measurement offset.

11. The apparatus of claim 10, wherein the one or more processors are further configured to:
generate, based at least in part on the second BWP measurement offset, a BWP measurement offset profile that associates one or more BWP measurement offsets with a transmission channel, the transmission channel being based at least in part on an active BWP and a second BWP that is outside of the active BWP,
wherein the first BWP measurement offset is based at least in part on the BWP measurement offset profile.

12. An apparatus for wireless communication at a user equipment (UE), comprising:
a memory; and
one or more processors, coupled to the memory, configured to:
obtain an indication of a bandwidth part (BWP) measurement offset associated with a layer 1 measurement; and
communicate in a wireless network based at least in part on using the BWP measurement offset in the layer 1 measurement.

13. The apparatus of claim 12, wherein the one or more processors are further configured to:
receive a synchronization signal block (SSB) in an initial BWP;
transmit a random access channel in the initial BWP based at least in part on the SSB; and
transmit an uplink transmission in an active BWP based at least in part on receiving the SSB in the initial BWP,
wherein the BWP measurement offset is based at least in part on the uplink transmission.

14. The apparatus of claim 12, wherein the one or more processors are further configured to:
receive a synchronization signal block (SSB) in an initial BWP that is outside of an active BWP;
receive an instruction that indicates to transmit a random access channel in the active BWP; and
transmit the random access channel in the active BWP based at least in part on receiving the SSB in the initial BWP.

15. The apparatus of claim 14, wherein the one or more processors, to transmit the random access channel, are configured to:
transmit the random access channel based at least in part on a power level associated with the SSB.

16. The apparatus of claim 12, wherein the one or more processors, to obtain the BWP measurement offset, are configured to:
receive a synchronization signal block (SSB) based at least in part on using a second BWP that is outside of an active BWP;
receive an offset calibration reference signal based at least in part on using the active BWP; and
calculate the BWP measurement offset based at least in part on receiving the SSB and the offset calibration reference signal.

17. The apparatus of claim 16, wherein the one or more processors are further configured to:
calculate a first signal metric based at least in part on the offset calibration reference signal;
calculate a second signal metric based at least in part on the SSB; and
calculate a difference between the first signal metric and the second signal metric,
wherein the one or more processors, to calculate the BWP measurement offset, are configured to:
calculate the BWP measurement offset based at least in part on the difference.

18. The apparatus of claim 16, wherein the one or more processors are further configured to:
transmit the BWP measurement offset to a network node; and
receive a UE-specific threshold that is based at least in part on the active BWP,
wherein the one or more processors, to communicate in the wireless network based at least in part on using the BWP measurement offset in the layer 1 measurement, are configured to:
use the UE-specific threshold in the layer 1 measurement.

19. The apparatus of claim 18, wherein the UE-specific threshold comprises at least one of:
a radio link failure threshold,
a reference signal received power threshold,
a reference signal received quality threshold, or
a beam failure detection threshold.

20. The apparatus of claim 12, wherein the layer 1 measurement is based at least in part on at least one of:
a beam failure procedure,
a radio link failure procedure, or
a layer 1 reference signal received power procedure.

21. The apparatus of claim 12, wherein the one or more processors are further configured to:
receive a synchronization signal block (SSB) based at least in part on using a second BWP that is outside of an active BWP; and
filter the SSB based at least in part on a time duration that is based at least in part on a frequency difference between the second BWP and the active BWP.

22. A method of wireless communication performed by a network node, comprising:
determining a bandwidth part (BWP) measurement offset associated with a layer measurement; and
transmitting an indication of the BWP measurement offset.

23. The method of claim 22, further comprising:
receiving a wireless signal from a user equipment (UE),
wherein determining the BWP measurement offset is based at least in part on the wireless signal.

24. The method of claim 22, further comprising:
transmitting an offset calibration reference signal within an active BWP; and
transmitting a second reference signal in a second BWP that is outside of the active BWP.

25. The method of claim 24, further comprising:
receiving a BWP measurement offset from a first user equipment (UE);
calculating a UE-specific threshold based at least in part on the BWP measurement offset; and
transmitting the UE-specific threshold to the first UE or a second UE that is different from the first UE.

26. A method of wireless communication performed by a user equipment (UE), comprising:
obtaining an indication of a bandwidth part (BWP) measurement offset associated with a layer 1 measurement; and
communicating in a wireless network based at least in part on using the BWP measurement offset in the layer 1 measurement.

27. The method of claim 26, wherein obtaining the indication of the BWP measurement offset further comprises:
obtaining the indication from a network node and based at least in part on at least one of:
a radio resource control message,
downlink control information, or
a medium access control (MAC) control element (CE).

28. The method of claim 26, further comprising:
receiving a synchronization signal block (SSB) in an initial BWP;
transmitting a random access channel in the initial BWP based at least in part on the SSB; and
transmitting an uplink transmission in an active BWP based at least in part on receiving the SSB in the initial BWP,
wherein the BWP measurement offset is based at least in part on the uplink transmission.

29. The method of claim 26, further comprising:
generating a layer 1 metric based at least in part on the BWP measurement offset.

30. The method of claim 29, wherein the layer 1 metric is an updated layer 1 metric, and wherein generating the layer 1 metric further comprises:
generating an initial layer 1 metric without using the BWP measurement offset; and
generating the updated layer 1 metric by modifying the initial layer 1 metric based at least in part on the BWP measurement offset.
